(19) United States
(12) Patent Application Publication
(10) Pub. No.: US 2019/0156225 A1
(43) Pub. Date: May 23, 2019

(54) OPTIMIZING A HIERARCHICAL RULE-BASED DECISION POLICY

(71) Applicant: International Business Machines Corporation, Armonk, NY (US)

(72) Inventors: Clement Agarini, Valbonne (FR); Jean-Michel Bernelas, Valbonne (FR); Fanny Bischoff, Biot (FR); Jerome Delattre, Valbonne (FR); Ulrich Junker, Biot (FR); Guilhem Molines, Valbonne (FR)

(21) Appl. No.: 15/817,396

(22) Filed: Nov. 20, 2017

(51) Int. Cl. G06N 5/04; G06F 7/02; G06F 17/30

(52) U.S. Cl. CPC G06N 5/045; G06F 17/30958; G06F 7/02

(57) ABSTRACT

Approaches presented herein enable optimizing a hierarchical rule-based decision policy. An initial domain of values for each decision of a ruleset is extracted. Using the initial domain of values and a hierarchical structure of the ruleset, a reduced domain of values for each decision is computed starting from the lowest level decision. Each of the reduced domain of values upwards in the hierarchical structure is propagated upwards. A completeness and consistency analysis for each decision is then performed based on the propagation to identify any missing and/or arbitration rules for the policy.

### TECHNICAL FIELD

The subject matter of this invention relates generally to rules management. More specifically, aspects of the present invention provide a solution for optimizing a hierarchical rule-based decision policy.

### BACKGROUND

Organizations such as government bodies, insurance companies, credit institutes, and sales organizations define decision policies in order to decide large volumes of cases in a consistent way. When defining such a policy, a policymaker needs to make decisions for a whole population of cases instead of deciding a single case, which corresponds to the usual scenario in decision making. As the number of possible cases may be large or even infinite, a policymaker will not be able to decide each possible case individually when defining the policy, but needs to follow some principles. For example, the policymaker may regroup similar cases and make the same decision for those cases. Such a generic decision can be represented in form of a condition-action rule. The action of such a rule consists in the decision to be made and the condition limits the application of the rule to the cases for which this decision should be made. A decision policy can be represented by several of such rules. A policymaker can thus define the policy by choosing a sufficient number of rules.

Typically, the cases are characterized in terms of multiple attributes which all may impact the decision. If there are many attributes, this will lead to a highly dimensional space of cases that need to be covered by the rules. This may require an exponential number of rules which is prohibitive in practice. Often it is possible to factorize the policy and to break it into several pieces. Each piece of the policy depends only on some of the attributes and aggregates information from these attributes into decisions of a first level. Other pieces aggregate information from first-level decisions into decisions of a second level and this process may be repeated until the final decision is aggregated from lower-lever decisions. Each piece of the decision policy may be represented by several rules as described before, but those rules inspect only a subset of the attributes or intermediate decisions and their actions are limited to the intermediate decision of the considered piece.

Once the decision policy has been defined in this way, the rules representing the policy may be formulated in a formal rule language. A rules engine may then be supplied with the description of those rules. Given a description of a case, the rule engine is then able to decide the case by applying the rules.

### SUMMARY

In general, embodiments of the present invention enable optimizing a hierarchical rule-based decision policy. An initial domain of values for each decision of a ruleset is extracted. Using the initial domain of values and a hierarchical structure of the ruleset, a reduced domain of values for each decision is computed starting from the lowest level decision. Each of the reduced domain of values in the hierarchical structure is propagated upwards. A completeness and consistency analysis for each decision is then performed based on the propagation to identify any missing and/or arbitration rules for the policy.

One aspect of the present invention includes a method for optimizing a hierarchical rule-based decision policy, the method comprising: extracting, from a ruleset, an initial domain of values for each decision within the ruleset; computing, based on the initial domain of values and a hierarchical structure of the ruleset, a reduced domain of values for each decision starting from the lowest level decision; propagating each of the reduced domain of values upwards in the hierarchical structure; and determining a completeness and consistency for each decision based on the propagation.

Another aspect of the present invention includes a computer program product embodied in a computer readable medium that, when executed by a computer device, performs a method for optimizing a hierarchical rule-based decision policy, the method comprising: extracting, from a ruleset, an initial domain of values for each decision within the ruleset; computing, based on the initial domain of values and a hierarchical structure of the ruleset, a reduced domain of values for each decision starting from the lowest level decision; propagating each of the reduced domain of values upwards in the hierarchical structure; and determining a completeness and consistency for each decision based on the propagation.

Yet another aspect of the present invention includes a system for optimizing a hierarchical rule-based decision policy, comprising: a memory medium comprising instructions; a bus coupled to the memory medium; and a processor coupled to the bus that when executing the instructions causes the system to perform a method, comprising: extracting, from a ruleset, an initial domain of values for each decision within the ruleset; computing, based on the initial domain of values and a hierarchical structure of the ruleset, a reduced domain of values for each decision starting from the lowest level decision; propagating each of the reduced domain of values upwards in the hierarchical structure; and determining a completeness and consistency for each decision based on the propagation.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture 10 in which the invention may be implemented according to an illustrative embodiment of the present invention;

FIG. 2 depicts a cloud computing environment according to an embodiment of the present invention;

FIG. 3 depicts abstraction model layers according to an embodiment of the present invention;

FIG. 4 shows a first schematic diagram 200 illustrating an exemplary environment for implementation according to an illustrative embodiment of the present invention;

FIG. 5 shows an example dependency diagram 300 related to a hierarchical decision policy according to an illustrative embodiment of the present invention;

FIG. 6 shows an example decision table 400 for discount according to an illustrative embodiment of the present invention;

FIG. 7 shows an example decision table 500 for a product family according to an illustrative embodiment of the present invention;

FIG. 8 shows an example decision table 600 for fidelity points according to an illustrative embodiment of the present invention;

FIG. 9 shows an example decision table 700 for category according to an illustrative embodiment of the present invention;

FIG. 10 shows an example flowchart 800 for processes related to hierarchical rule analysis component 160 according to an illustrative embodiment of the present invention;

FIG. 11 shows an example flowchart 900 for processes related to decision domain detection component 170 according to an illustrative embodiment of the present invention; and

FIG. 12 shows an example flowchart 1000 for process related to flat rule analysis component 180 according to an illustrative embodiment of the present invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing”, “detecting”, “determining”, “evaluating”, “receiving”, or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission, or viewing devices. The embodiments are not limited in this context.

As stated above, embodiments of the present invention enable optimizing a hierarchical rule-based decision policy. An initial domain of values for each decision of a ruleset is extracted. Using the initial domain of values and a hierarchical structure of the ruleset, a reduced domain of values for each decision is computed starting from the lowest level decision. Each of the reduced domain of values upwards in the hierarchical structure is propagated upwards. A completeness and consistency analysis for each decision is then performed based on the propagation to identify any missing and/or arbitration rules for the policy.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows. On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

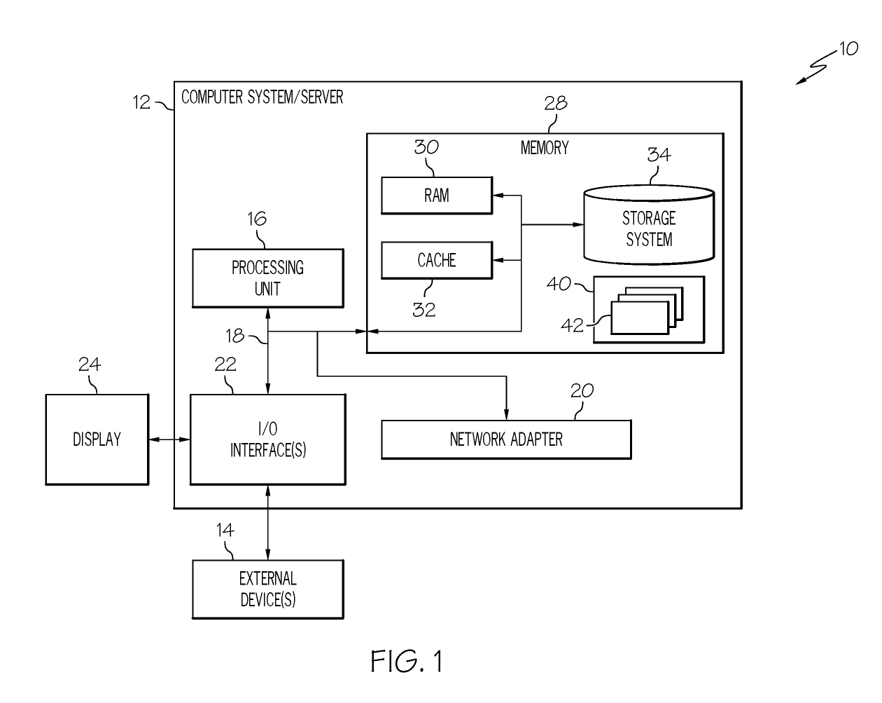

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

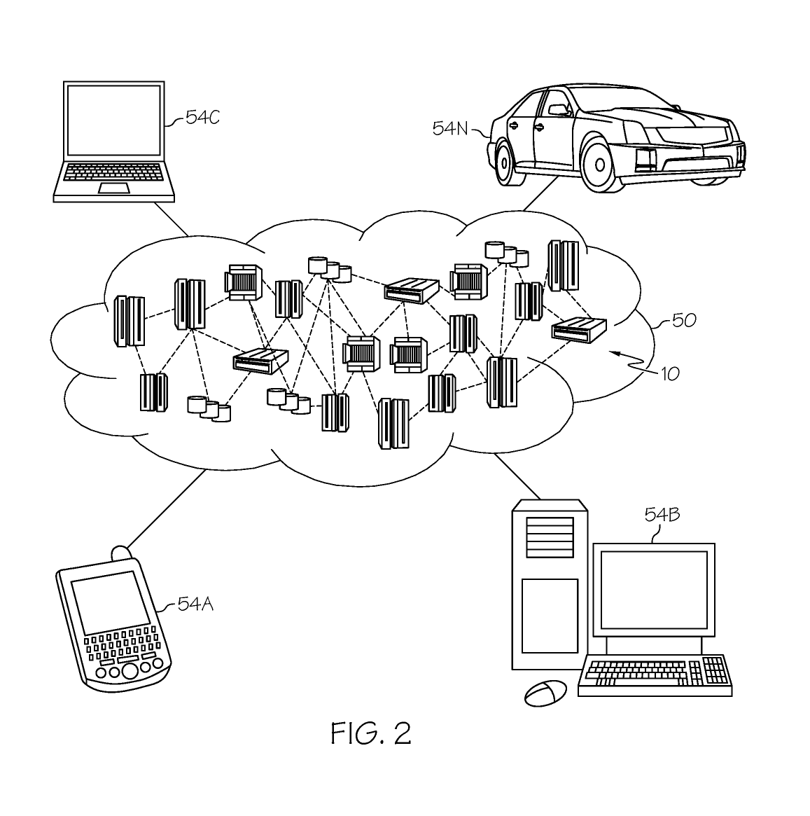

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

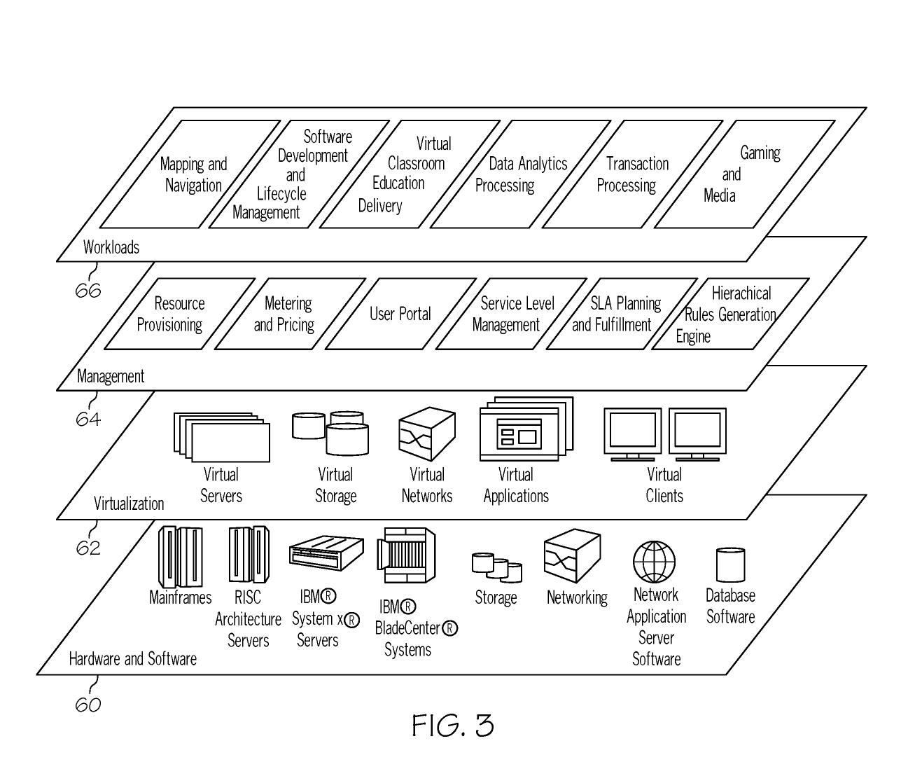

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System X® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is hierarchical rules generation engine, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and managed services enablement. As mentioned above, all of the foregoing examples described with respect to FIG. 3 are illustrative only, and the invention is not limited to these examples.

It is understood that all functions of the present invention as described herein typically may be performed by the command identification functionality of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

Inventors of the invention described herein have discovered that, although there are methods for analyzing completeness and consistency of flat policies, the analysis of hierarchical decision policies has found less attention. Existing solutions for rule analysis suppose that a single rule needs to be applied to make a decision for a given case. They could be applied to subsets of rulesets that support a hierarchical policy, but this requires that several difficulties are addressed. Firstly, all rules to be analyzed need to contribute to the same intermediate decision. Hence, the policymaker (or analyst) needs to conduct a dedicated rule analysis for each intermediate decision. At each step of this process, the policymaker has to select all relevant rules for the current decision. Secondly, the policymaker has to provide a description of the intermediate cases, which means the information that is available when the intermediate decision is made. Thirdly, the policymaker has to provide a definition of the intermediate decision and describe the possible options that may be chosen for making the decision. Given all this information about the intermediate cases and intermediate decisions, existing rule analysis methods will be able to generate missing rules for making the considered piece of the decision policy complete and arbitration rules for making this piece consistent.

Unfortunately, this process may result in false positives (i.e., missing rules and arbitration rules that address cases that will not occur when applying the hierarchical decision policy). For example, they may treat certain interest rates out of range even if those interest rates can never occur as the result of a preceding decision. Rule analysis methods for flat decision policies do not have knowledge about the whole hierarchical decision policy, its sub-decisions, and the dependencies between them. As such, they are lacking precise knowledge of the intermediate cases that arise when making an intermediate decisions and thus necessarily result in false positives. False positives are counterproductive as they require extra work from the analyst who needs to detect the false positives. It would be desirable to avoid such problems and to determine that the ruleset is complete and consistent.

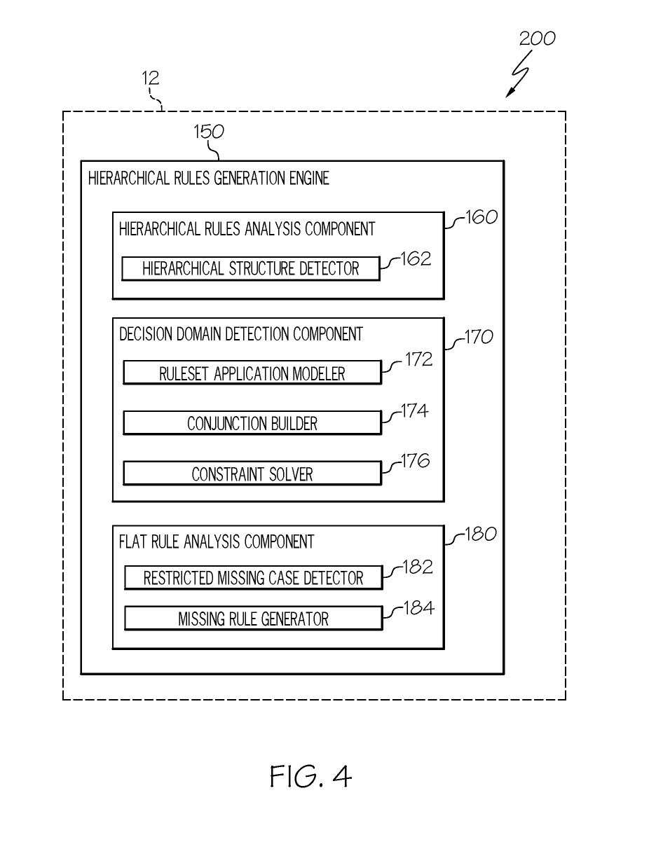

Referring now to FIG. 4, a block diagram 200 describing the functionality discussed herein according to an embodiment of the present invention is shown. It is understood that the teachings recited herein may be practiced within any type of computing environment (e.g., computer system 12). To this extent, the teachings recited herein may be practiced within a stand-alone computer system or within a networked computing environment (e.g., a client-server environment, peer-to-peer environment, distributed computing environment, cloud computing environment, and/or the like). If the teachings recited herein are practiced within a networked computing environment, each physical server need not have a marketing alert mechanism 50 (hereinafter “system 50”). Rather, system 50 could be loaded on a server or server-capable device that communicates (e.g., wirelessly) with the physical server to present an alert message to a mobile device of a user based on an inventory event of a product of interest to the user and a location of the user relative to a retail location.

Regardless, as depicted, system 50 can be implemented as program/utility 40 on computer system 12 of FIG. 1 and can enable the functions recited herein. It is further understood that system 50 can be incorporated within or work in conjunction with any type of system that receives, processes, and/or executes commands with respect to IT resources in a networked computing environment. Such other system(s) have not been shown in FIG. 2 for brevity purposes. As shown, hierarchical rules generation engine 150 (hereinafter referenced as “system 50”) includes hierarchical rule analysis component 160, decision domain detection component 170, and flat rule analysis component 180. The functions/acts of each component are described in detail below. Hierarchical rule analysis component 160 includes hierarchical structure detector 162. Decision domain detection component 170 includes ruleset application modeler 172, conjunction builder 174, and constraint solver 176, Flat rule analysis component 180 includes restricted missing case detector 182, and missing rule generator 184.

Decision policies for loan validation, claim processing, discount attribution, and/or the like, usually involve some intermediate decisions and are thereby hierarchical in nature. For example, a sales organization may attribute discounts to products bought by a customer based on the product itself, the sales period, the customer age, and the shopping history of the customer. The policymaker could define a flat decision policy for deciding the discount. In this policy, the discount depends on the four given attributes and the policymaker would need to choose a discount for each possible combination of values for those attributes. If the same discount is attributed to a family of similar cases, then those cases may be decided by the same rule. Whereas this may reduce the workload of the policymaker, the number of rules may still be exponential in the number of attributes.

Alternatively, the policymaker may reduce the dimensionality of the case space by introducing intermediate decisions. For example, the policymaker may state that the discount depends on two intermediate decisions, namely a number of fidelity points of the customer and the product family. Each product may belong to a clearly defined product family, meaning that the decision of the product family only depends on the product and not on the other attributes. As far as the fidelity points are concerned, the policymaker may decide that they are attributed dependent on the category of the customer and whether the sales period is promotional or not. The policymaker may further decide that the category should depend on long-term characteristics such as the customer age and the cart (i.e., monetary) value of all items that the customer has bought in the past, but not on the sales period and the product.

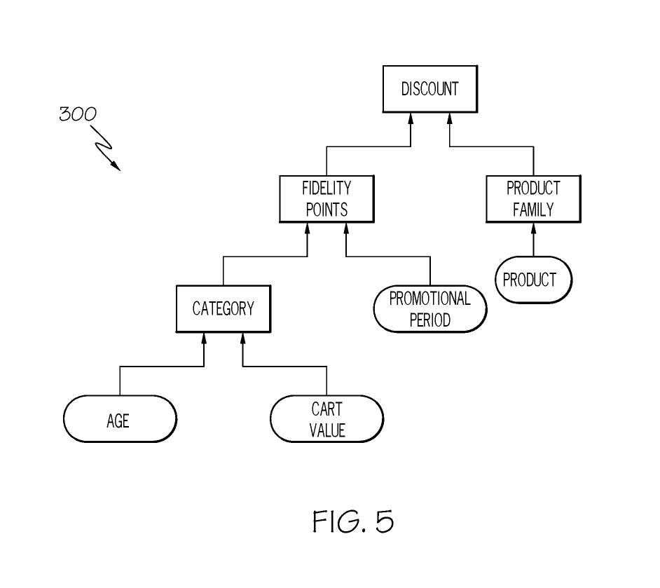

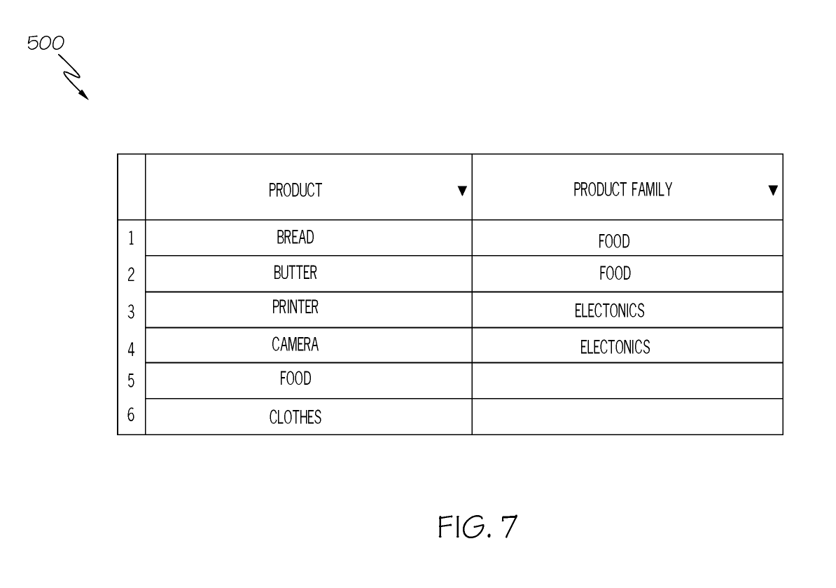

FIG. 5 shows an example dependency diagram 300 related to a hierarchical decision policy according to an illustrative embodiment of the present invention. The hierarchical decision policy discussed herein is illustrative only and merely provides an example for the detailed discussion related to the functions and features of system 50 that follows. It is not intended to be limiting. As shown, dependency diagram 300 depicts the final and intermediate decisions by square boxes (i.e., category, fidelity points, product family, and discount) and the attributes of the cases by rounded boxes (i.e., age, cart value, promotional period, and product). Dependencies are depicted by arrows leading from the independent decision or attribute to the dependent decision. In some organizations, the policymaker may define the dependency diagram (or influence diagram) in a deliberate way as illustrated in FIG. 7 and use it when representing the policy in terms of rules or decision tables. Note that decision tables are typically just a tabular representation of rules that have a regular form. Other organizations may not define an explicit diagram, but the dependency structure may be implicit in the rules and decision tables defined by this organization.

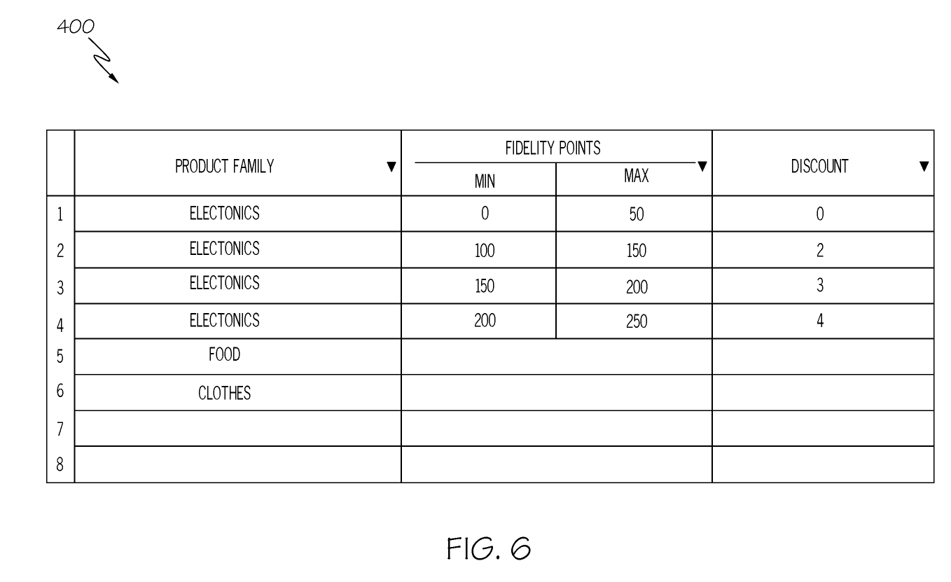

In the example, the hierarchical decision policy may be represented in terms of four decision tables shown in FIGS. 6-9. FIG. 6 shows an example decision table 400 for discount. In an illustrative example, assume electronics products may receive a discount of 2% if a customer has received at least 100, but less than 150 fidelity points. Higher numbers of fidelity points may lead to higher discounts, but no discount is given if the customer has less than 50 fidelity points. The discounts for other product families such as food and clothes are not shown in order to keep the example simple.

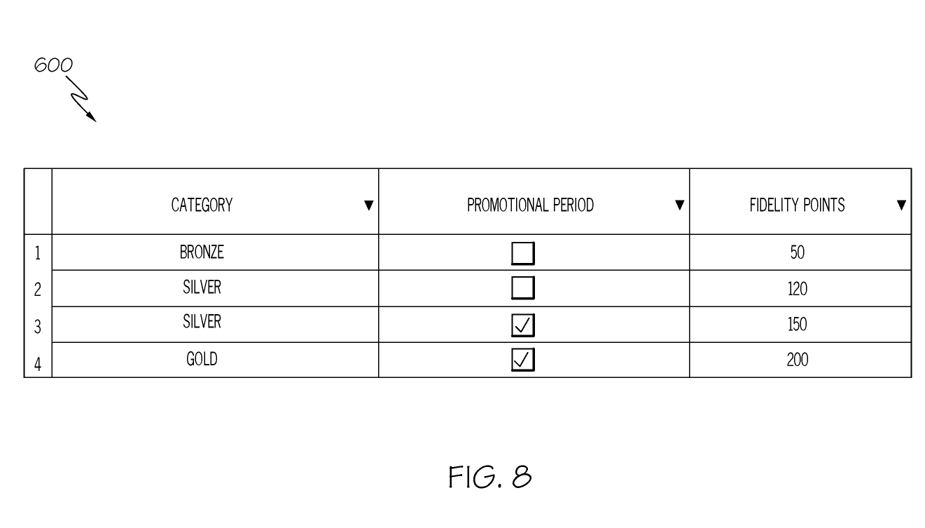

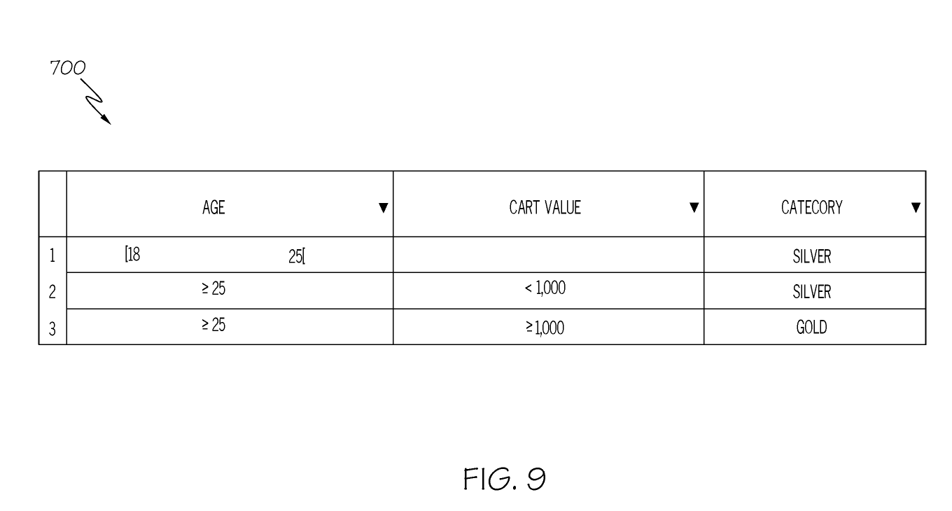

FIG. 7 shows an example decision table 500 for a product family. As shown, a product family for products such as a printer and camera are defined, as well as bread and butter. Again, only some products are shown to keep the presentation simple. FIG. 8 shows an example decision table 600 for fidelity points. As shown, 50 fidelity points are given to “Bronze” customers in a normal sales period. “Silver” customers receive 120 points in a normal period and 150 in a promotional period. Moreover, “Gold” customers receive 200 points in a promotional period. This table is shown in full detail. Finally, FIG. 9 shows an example decision table 700 for category. As shown, it is used to determine a category of the customer based on an age and cumulated cart value. Customers who have bought less than $1,000 in products or who are between 18 and 25 are considered Silver customers. Customers who are 25 or older and who have bought items for $1,000 or more are considered Gold customers. This table is also shown in full detail.

A decision policy should be able to decide each case that may arise. As such, the decision tables need to cover all available products, all possible customer ages, all possible cart values, and this for standard sales periods as well as for promotional sales periods. For example, the decision table for category determination is incomplete in this respect as it does not treat customers younger than 18. In order to find these missing cases, known methods for analyzing the completeness of rulesets may be used. They may, for example, report a missing case for customers of age 17 as those customers do not receive a category. The same remark holds true for customers of age 16 or younger as well, thus leading to further missing cases. These missing cases can be characterized by a single condition, namely that of having an age of less than 18, and can thus be regrouped into a family of missing cases. Existing methods for completeness analysis are able to determine those families of missing cases. For example, they may report the considered family in terms of the following condition: an age is less than 18.

Those rule analysis methods can also be applied to decision tables that depend on intermediate decisions. When applied to the decision table for fidelity points (FIG. 8), they may identify the following two families of cases that involve intermediate decisions and that are not addressed by the decision table: (1) the category is Bronze and the promotional period is true, and (2) the category is Gold and the promotional period is false. As those families of cases involve intermediate decisions, it is necessary to ask whether those intermediate decisions can arise for some real case. Addressing the second family first, the category of Gold is attributed to customers who are at least 25 years old and who bought for more than $1,000. Hence, there are cases where the category is Gold and the sales period is not a promotional period. These cases need to be addressed. Therefore, the second case family is a true positive and needs to be retained.

When looking at the first family, it can be observed that there is no real case where the category Bronze is attributed. Hence, it is not necessary to address cases where the category is Bronze and the sales period is a promotional one. This case corresponds to a false positive of a missing case family, and therefore needs to be discarded. Detecting those false positives require a global understanding of the hierarchical decision policy. For example, when performing a completeness analysis for the decision table for discounts, the following family of missing cases is reported. Again, this family involves intermediate decisions: the product family is electronics and the fidelity points is at least 50 and less than 100. This appears to be a true positive since the intermediate decision about the electronics product family is made for products such as printers or cameras, and an intermediate decision about 50 fidelity points is made if the category is Bronze and the sales period is non-promotional. However, it should be noted that the category of Bronze is not attributed in any real case. As there is no other possibility to attribute at least 50, but less than 100 fidelity points, the family of missing cases reported above is a false positive. As such, this family can be discarded.

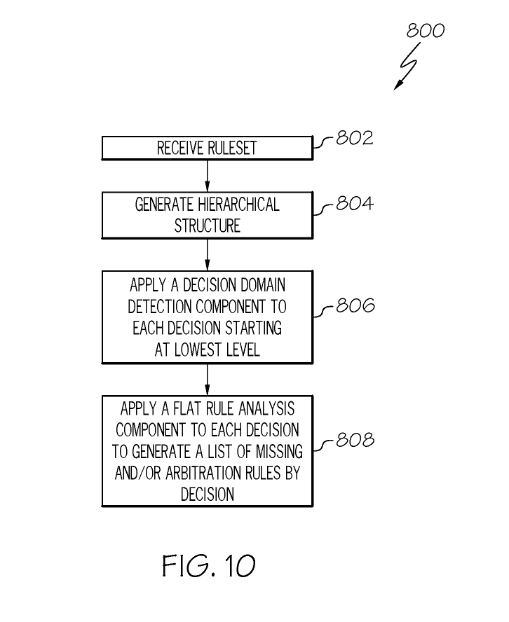

Hierarchical rule analysis component 160 of system 50, as executed by computer system/server 12, is configured to derive a list of missing and/or arbitrary rules by decision for a given ruleset. FIG. 10 shows an example flowchart 800 for processes related to hierarchical rule analysis component 160. At 802, hierarchical rule analysis component 160 is provided with a set of condition-action rules (or a ruleset). In an embodiment, at 804, hierarchical structure detector 162 is configured to perform a syntactic analysis of the ruleset to generate a hierarchical structure. In another embodiment, a hierarchical structure is provided along with the ruleset. The hierarchical structure models the dependencies between attributes of cases, intermediate decisions, and final decisions (e.g., FIG. 5). It may also define the actions that can be used to make a decision.

Given a hierarchical structure, decision domain detection component 170 of system 50, as executed by computer system/server 12, is configured to compute a reduced domain for each decision while starting with decisions on the lowest levels and then proceeding to decisions of upper levels, at 806. The reduced domain contains the options for the decision that are attainable by making lower-level decisions. This step results in a constrained hierarchical structure which constrains each decision by a domain. Flat rule analysis component 180 of system 50, as executed by computer system/server 12, is configured to analyze each decision in constrained hierarchical structure 806 for completeness and correctness. At 808, flat rule analysis component 180 generates a list of missing and/or arbitration rules by decision. Furthermore, it may generalize those problematic cases into missing rules and/or arbitration rules for each decision. These rules will permit the policymaker to make the ruleset complete and consistent. They contain placeholders, thus allowing the policymaker to define which decision should be made in those problematic cases.

For example, system 50 may report the two missing rules concerning the decisions about category and fidelity points that correspond to the true positives discussed above, namely: (1) if the age is less than 18, then set the category to <a category>, and (2) if the category is Gold and the promotional period is false, then set the number of fidelity points to <a number>. However, system 50 will not report the two other missing rules discussed above as they are false positives, namely: (1) if the category is Bronze and the promotional period is true. then set the number of fidelity points to <a number>, and (2) if the product family is electronics and the number of fidelity points is at least 50 and the number of fidelity points is less than 100, then set the discount to <a number>.

To that end, hierarchical structure detector 162 first analyzes the actions of all rules in order to extract the decisions. For example, if a rule assigns a value to an attribute such as the category or the fidelity points, it will create a decision. Hierarchical structure detector 162 then adds this decision to a store (or repository) of decisions if this store does not already contain the decision. Hierarchical structure detector 162 also creates a list of actions for making this decision, as this information will be needed to create an initial domain for the decision in a later step. In the second step, hierarchical structure detector 162 analyzes the conditions of all rules in order to extract the attributes of the cases. For example, if the rule reads the value of an attribute such as the customer age and no decision has been created for this attribute, hierarchical structure detector 162 will create a case attribute. It will then add this case attribute to a store of case attributes if the store does not contain it already. In a third step, hierarchical structure detector 162 analyzes all rules to extract the dependencies.

For example, if a rule reads the value of an attribute and assigns a value to another attribute, then there is a dependency between those attributes. Hierarchical structure detector 162 retrieves the corresponding case attributes and decisions from the respective stores and creates a dependency that links those objects. Note that decision tables can be analyzed in a similar way as they can be seen as a set of rules of particular form. Hence, hierarchical structure detector 162 will be able to generate hierarchical structure 300 shown in FIG. 5 by exploring the decision tables of the example.

Decision domain detection component 170 computes a reduced domain for each decision in the hierarchical structure. When processing a decision, decision domain detection component 170 analyzes the rules to determine any actions that can be applied by the rules to make the decision based on a reduced domain for decisions of lower levels. The reduced domain thus needs to be previously computed. Decision domain detection component 170 is therefore applied to decisions on the lowest level before it is applied to decisions of higher levels.

In one embodiment, the rules may make a decision by assigning a value to an attribute. The domain of this decision should therefore contain all values such that there exists some rule that assigns this value and that is applicable supposing that lower-level decisions have values that belong to their reduced domains. These values can be determined by modeling the rule behavior in form of constraint graphs and by leveraging known constraint solving techniques as it will be described below. Other embodiments may involve more complex forms of making decisions, e.g., by aggregating values resulting from applying multiple rules. Whereas those embodiments may require more complex forms of constraint graphs, the overall approach for computing reduced domains can be used for these more complex decisions as well.

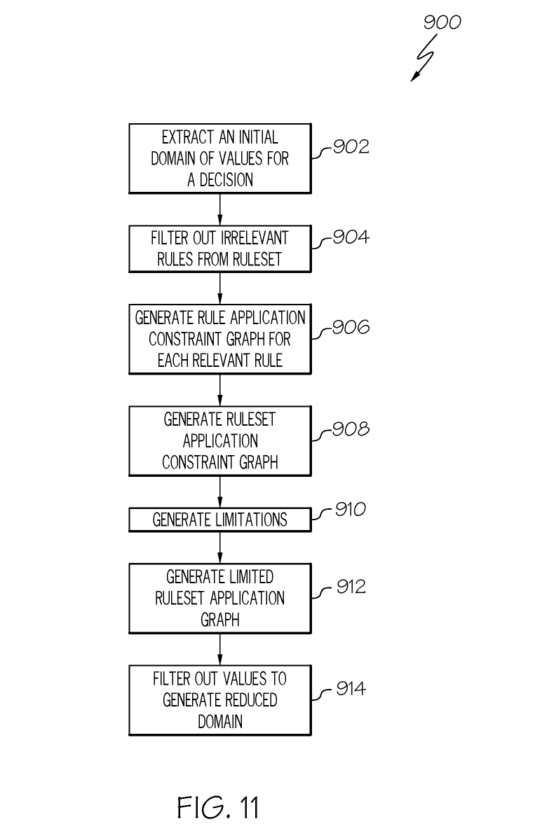

FIG. 11 shows an example flowchart 900 of decision domain detection component 170. It is supplied with a ruleset, a hierarchical structure, and a decision belonging to this structure. At 902, decision domain detection component 170 extracts an initial domain for a decision based on the actions that are used for making the decision. If those actions are assigning fixed values, decision domain detection component 170 may set up an initial domain consisting of these fixed values. If those actions are assigning an expression of type integer, the initial domain will consist of all integers. As explained below, at 904, decision domain detection component 170 will filter out those values that cannot be assigned by any applicable rule.

For this purpose, decision domain detection component 170 analyzes the action of each rule and checks whether this action may make the given decision. If yes, the rule is included in a list of rules that are making the decision. If no, the rule is irrelevant and not included in this list. At 906, ruleset application modeler 172 then builds a rule application constraint graph for each relevant rule to describe that the rule condition is satisfied and a second one that states that the action has been applied. For example, this can be illustrated by a rule that attributes 50 fidelity points if the category is Bronze and the promotional period is false. The rule can be more clearly stated as: if the category is Bronze and the promotional period is false, then set the number of fidelity points to 50. The condition of this rule is satisfied if the category is Bronze and the promotional period is false. This can be directly formulated in a constraint language that has comparison and Boolean constraints. The action of the rule has been applied if the number of fidelity points is 50. This can be expressed in the constraint language in terms of a simple equality constraint. The rule application constraint graph of the considered rule then is the conjunction of both constraints (i.e., the category is Bronze and the promotional period is false) and the number of fidelity points is 50).

Once ruleset application modeler 172 has built these rule application constraint graphs for each relevant rule, it builds a ruleset application constraint graph which is the disjunction of these rule application constraint graphs, at 908. For example, the ruleset application constraint graph obtained for the rules of the fidelity points decision expresses the following constraint that one of the following conditions is true: (1) the category is Bronze and the promotional period is false and the number of fidelity points is 50, (2) the category is Silver and the promotional period is false and the number of fidelity points is 120, (3) the category is Silver and the promotional period is true and the number of fidelity points is 150, or (4) the category is Gold and the promotional period is true and the number of fidelity points is 200.

The constraint is true if and only if one of the four rules is applicable and has been applied. Decision domain detection component 170 will use this ruleset application constraint graph to test whether possible values for making the decision are consistent. For example, it is not possible to attribute 100 fidelity points since the constraint “the number of fidelity points is 100” is inconsistent with respect to the ruleset application graph. Indeed, if the constraint “the number of fidelity points is 100” were true, then none of the disjuncts of the considered ruleset application constraint graph would be true. Indeed, only the values of 50, 120, 150, and 200 are consistent. Some rules may not be applicable given the reduced domains of lower-level decisions. At 910, decision domain detection component 170 computes additional constraints (or limitations) limiting the applicability of rules based on these domains. For example, if the category has a reduced domain consisting of Silver and Gold, but not Bronze, decision domain detection component 170 will generate the following limitation: the category is Silver or the category is Gold.

Conjunction builder 174 is configured to construct a limited ruleset application constraint graph based on all limitations and the ruleset application constraint graph which represents the conjunction of these given constraint graphs, at 912. In the final step, at 914, decision domain detection component 170 filters out values from an initial domain that are inconsistent with respect to the limited ruleset application constraint graph. In an embodiment, it uses constraint solver 176 for computing the reduced domain. If the initial domain is finite, it may tentatively assign each value from the initial domain and determine whether the ruleset application constraint graph has a solution under this assignment. A large variety of constraint-solving techniques based on search and inference are known in the art. If the initial domain is infinite, but totally ordered, decision domain detection component 170 may use bound reduction techniques and compute the reduced domain in the form of an interval. Again, those methods are known in the art.

For example, decision domain detection component 170 may test the consistency of the value 50 with respect to the limited ruleset application constraint graph. For this purpose, it will seek a solution of the limited ruleset application constraint graph under the additional constraint that the number of fidelity points is 50. Given this additional constraint, constraint solver 176 will deduce that the following constraints are all false: (1) the number of fidelity points is 120, (2) the number of fidelity points is 150, and (4) the number of fidelity points is 200.

It will furthermore deduce that all disjuncts of the ruleset application constraint are false, except for the first one. Hence, it is necessary that the first disjunct is true since otherwise the whole ruleset application constraint would be false. From this, constraint solver 176 can deduce that the following constraints are true: (1) the category is Bronze, (2) the promotional period is false, and (3) the number of fidelity points is 50. However, this contradicts the limitation that imposes that the category is equal to Silver or Gold. Following this kind of reasoning, constraint solver 176 deduces that the number of fidelity points cannot be 50. Hence, decision domain detection component 170 will not include this value in the reduced domain for the fidelity point decision.

Decision domain detection component 170 will do these consistency checks for all values that may be used for making the decisions. The values 120, 150, 200 are all consistent with respect to the limited ruleset application constraint graph since constraint solver 176 will deduce that the category is Silver (or Gold) in those cases, which satisfies the limitation. Hence, decision domain detection component 170 will return {120, 150, 200} as the reduced domain for the fidelity point decision. The value of 50 has not been included since the category could not be Bronze, which was due to the reduced domain of {Silver, Gold} for the category. Hence, this example shows how reducing a domain may propagate through the hierarchical structure.

In order to achieve this effect, decision domain detection component 170 needs to compute a reduced domain for the category decision before that of the fidelity point decision. The category decision does not depend on a lower-level decision, meaning that no limitations are obtained in this first step. The limited ruleset application constraint graph of this decision is one of the following conditions is true: (1) the age is at least 18 and the age is less than 25 and the category is Silver, (2) the age is at least 25 and the cart value is less than 1,000 and the category is Silver, or (3) the age is at least 25 and the cart value is at least 1,000 and the category is Gold. Extracting an initial domain results into two values, namely Silver and Gold, which are both consistent with the limited ruleset application constraint graph. Hence, decision domain detection component 170 will return {Silver, Gold} as the reduced domain for the category decision.

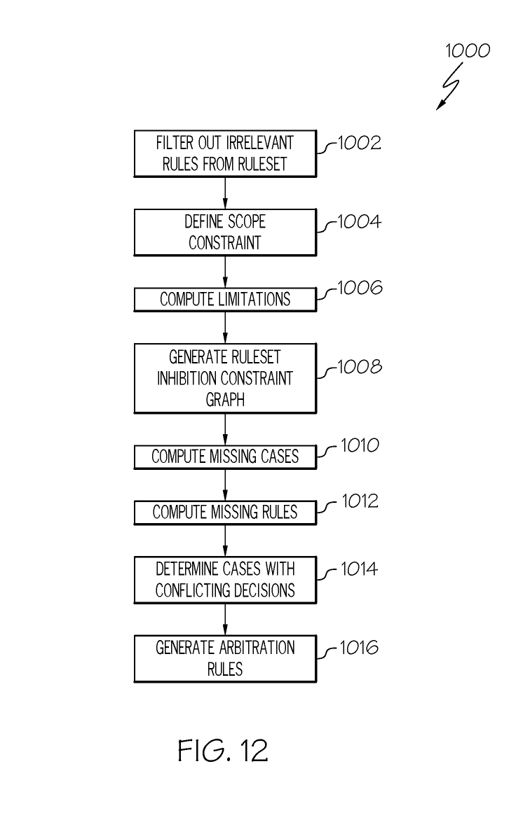

FIG. 12 shows an example flowchart 1000 for a process related to flat rule analysis component 180. It is supplied with a ruleset, a constrained hierarchical structure 806, and a decision belonging to this structure. Some steps are similar to that of the decision domain detection component 170. For example, flat rule analysis component 180 filters out irrelevant rules and keeps only those that may make the given decision, at 1002. The relevant rules should make a unique decision for each intermediate case, where an intermediate case is characterized by the values of some lower-level decisions and some of the real case attributes. These are all lower-level decisions and all case attributes on which the decision depends and these elements constitute the scope of the intermediate case. In order to conduct a flat rule analysis, an explicit description of this scope is necessary, since this scope defines the space of cases that need to be decided by the rules.

Flat rule analysis component 180 therefore extracts the scope from the hierarchical structure and defines a scope constraint, at 1004. This scope constraint expresses that all the decisions and case attributes in the scope must have values (i.e., must be different to make null). For example, the fidelity point decision depends on the category and the promotional period. Flat rule analysis component 180 will compute the following scope constraint to express that these decisions must have values: the category is not null and the promotional period is not null.

Furthermore, at 1006, flat rule analysis component 180 computes any limitations for the lower-level decisions in the scope (in the same way as the decision domain detection component 170). For example, it may compute the limitation that the category is Silver or Gold, which is expressed by the following constraint: the category is Silver or the category is Gold. This information, namely the scope, limitations, and the list of relevant rules, is sufficient to compute missing cases. Methods for computing missing cases are known in the art. Similar to the decision domain detection component 170, they may use constraint solving techniques. Instead of using these techniques for computing a reduced domain, they use them to compute a missing case (i.e., a case of the considered scope that is not decided by any of the rules). As this task is different to that of the computing reduced domain, a different constraint graph, namely a ruleset inhibition constraint graph, can be generated, at 1008. This constraint graph is satisfied if no rule is applicable. For example, the ruleset inhibition constraint graph for the fidelity point decision includes all of the following conditions being true: (1) the category is not Bronze or the promotional period is true, (2) the category is not Silver or the promotional period is true, (3) the category is not Silver or the promotional period is false, and (4) the category is not Gold or the promotional period is false. This constraint graph has two solutions, namely: (1) the category is Bronze and the promotional period is true, and (2) the category is Gold and the promotional period is false.

These solutions correspond to two missing cases if no limitation is taken into account. Restricted missing case detector 182 will, however, take the limitations into account and compute only those missing cases that satisfy the limitation constraints, such as the following limitation for the category decision: the category is Silver or the category is Gold. The first missing case listed above does not satisfy this limitation, meaning that a restricted missing case detector 182 will not report it. As the second missing case satisfies the limitation, the restricted missing case detector 182 will report this restricted missing case: the category is Gold and the promotional period is false, at 1010.

Flat rule analysis component 180 will also avoid the reporting of false positives requiring a global understanding of the hierarchical decision policy. As explained before, the decision domain detection component 170 computes a reduced domain {120, 150, 200} for the fidelity point decision. Flat rule analysis component 180 will thus take the following limitation into account when computing missing cases for the discount decision: the number of fidelity points is 120 or the number of fidelity points is 150 or the number of fidelity points is 200.

Missing case detector 182 will generate the following ruleset inhibition constraint graph for the discount decision (note that some parts are not shown, but those concerning electronic products are all shown) that all of the following conditions are true: (1) the product family is not electronics or the number of fidelity points is less than 0 or the number of fidelity points is at least 50, (2) the product family is not electronics or the number of fidelity points is less than 100 or the number of fidelity points is at least 150, (3) the product family is not electronics or the number of fidelity points is less than 150 or the number of fidelity points is at least 200, (4) the product family is not electronics or the number of fidelity points is less than 180 or the number of fidelity points is at least 250, and so on.

The constraint solver may explore the consequences of the assumption that the product family is electronics. According to this assumption, the first disjunct of the first four conditions is false, meaning that constraint solver 176 may reduce the constraint graph to the following one that states that all of the following conditions are true: (1) the number of fidelity points is less than 0 or the number of fidelity points is at least 50, (2) the number of fidelity points is less than 100 or the number of fidelity points is at least 150, (3) the number of fidelity points is less than 150 or the number of fidelity points is at least 200, and (4) the number of fidelity points is less than 180 or the number of fidelity points is at least 250.

Constraint solver 176 may then try out the different values for fidelity points in order to satisfy the limitation constraint. If the number of fidelity points were 120, the second condition would be false. Similarly, if the number of fidelity points were 150, the third condition would be false. Finally, if the number of fidelity points were 200, the fourth condition would be false. Hence, constraint solver 176 does not find any solution where the product family is electronics. As a consequence, it does not report the following false positive: the product family is electronics and the fidelity points is at least 50 and the fidelity points is less than 100. Hence, hierarchical rule analysis component 160 avoids reporting the false positives introduced earlier. It achieves this effect thanks to the computation of reduced domains.

Flat rule analysis component 180 may use missing rule generator 184 to generalize the missing cases into missing rules, at 1012. For example, when analyzing the category decision, a missing case may be found as the decision table for the category does not make a decision for customers of an age of 17. Missing rule generator 184 may generalize this missing case into a family of similar missing cases. This family may be characterized by the following condition: the age is less than 18. Methods for computing those families of missing cases are known in the art. Flat rule analysis component 180 may then use this condition and produce a missing rule for the following category decision: if the age is less than 18, then set the category to <a category>. A policymaker can then decide which category to attribute to customers less than 18. For example, the policymaker may attribute the category Copper. Adding such a rule may lead to new issues, meaning that the hierarchical rule analysis component 160 needs to perform a new rule analysis, including a re-computation of the reduced domains of decisions.

Flat rule analysis component 180 will not only analyze the given decision for completeness, but also for consistency. For this purpose, it seeks cases of the considered scope that lead to conflicting decisions, at 1014. For example, the discount decision has such cases. If the product family is electronics and the number of fidelity points is 180, the discounts of 3% and 4% may be both attributed. Methods for computing cases with conflicting decisions are known in the art. In addition to a scope and the set of relevant rules, they also need a definition of the decision. This definition lists the actions that the rules can use to make the decision and it also specifies which actions lead to incompatible results. For example, the discount decision is made by assigning an integer value to the discount attribute. Different integer values lead to incompatible results, meaning that two rules assigning different integer values are conflicting with each other.

Given this information, a detector of cases with conflicting decisions may detect the before-mentioned case and even generalize it into the following family of cases with conflicting decisions: the product family is electronics and the number of fidelity points is at least 180 and the number of fidelity points is less than 200. In principle, flat rule analysis component 180 may use such a case with conflicting decisions to generate an arbitration rule (i.e., a rule that decides those conflicting cases and that has a higher priority than the existing rules), at 1016, namely: if the product family is electronics and the number of fidelity points is at least 180 and the number of fidelity points is less than 200, then set the discount to <a number>. A policymaker then just needs to choose a definite discount in order to arbitrate those cases. Alternatively, the policymaker could also modify the conditions of the existing rules and ensure that only one of those rules is applicable to those cases.

These considerations would be valid if the number of fidelity points fell into the range between 180 and 200. According to the reduced domain of the fidelity points, these cases cannot arise. Hence, the family of cases with conflicting decisions is a false positive and its generation should be avoided. In order to achieve this, a generator of cases with conflicting decisions needs to take any limitations into account. A restricted generator will report only those cases with conflicting decisions that satisfy the limitations. Moreover, the restricted generator will need to obey the limitations when generalizing these cases into families of cases with conflicting decisions. Whereas the precise methods for doing the latter have not been elaborated in the art, it is sufficient to understand the additional steps that are necessary for computing restricted missing cases and to incorporate similar steps in the computation of cases with conflicting decisions. The result of this modification will be a restricted generator of cases with conflicting decisions and this restricted generator will avoid reporting the false positive in the example considered above.

Hierarchical rule analysis component 160 is thus able to report missing rules and arbitration rules for each decision while avoiding false positives. Those missing rules and arbitration rules have actions for making decisions and these actions have placeholders, thus allowing the policymaker to decide how to address the respective missing cases and the respective cases with conflicting decisions.

Process flowcharts 800, 900, and 1000 of FIGS. 10, 11, and 12, respectively, illustrate the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the Figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for optimizing a hierarchical rule-based decision policy. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for optimizing a hierarchical rule-based decision policy. In this case, the service provider can create, maintain, support, etc., a computer infrastructure that performs the process steps of the invention for one or more consumers. In return, the service provider can receive payment from the consumer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network and/or a wireless network). The network may comprise copper transmission cables, optical transmission fibers, wireless transmission, routers, firewalls, switches, gateway computers and/or edge servers. A network adapter card or network interface in each computing/processing device receives computer readable program instructions from the network and routes the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an document of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

It is apparent that there has been provided herein approaches for optimizing a hierarchical rule-based decision policy. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for optimizing a hierarchical rule-based decision policy, the method comprising:
extracting, from a ruleset, an initial domain of values for each decision within the ruleset;
computing, based on the initial domain of values and a hierarchical structure of the ruleset, a reduced domain of values for each decision starting from the lowest level decision;
propagating each of the reduced domain of values upwards in the hierarchical structure; and
determining a completeness and consistency for each decision based on the propagation.

2. The method of claim 1, further comprising generating the hierarchical structure of the ruleset by performing a syntactic analysis of the ruleset.

3. The method of claim 1, further comprising computing a reduced domain of values includes constructing a limited ruleset application graph and filtering out values from the initial domain that are inconsistent with the limited ruleset application constraint graph.

4. The method of claim 1, further comprising computing, based on the reduced domain of values, one or more missing cases.

5. The method of claim 4, wherein determing a completeness and consistency for each decision includes generating a list of missing rules based on the one or more missing cases.

6. The method of claim 1, wherein determining a completeness and consistency for each decision includes generating a list of arbitration rules.

7. The method of claim 6, wherein an arbitration rule is associated with a case having at least one conflicting decision.

8. A computer program product embodied in a computer readable medium that, when executed by a computer device, performs a method for optimizing a hierarchical rule-based decision policy, the method comprising:
extracting, from a ruleset, an initial domain of values for each decision within the ruleset;
computing, based on the initial domain of values and a hierarchical structure of the ruleset, a reduced domain of values for each decision starting from the lowest level decision;
propagating each of the reduced domain of values upwards in the hierarchical structure; and
determing a completeness and consistency for each decision based on the propagation.

9. The computer program product of claim 8, the method further comprising generating the hierarchical structure of the ruleset by performing a syntactic analysis of the ruleset.

10. The computer program product of claim 8, the method further comprising computing a reduced domain of values includes constructing a limited ruleset application graph and filtering out values from the initial domain that are inconsistent with the limited ruleset application constraint graph.

11. The computer program product of claim 8, the method further comprising computing, based on the reduced domain of values, one or more missing cases.

12. The computer program product of claim 11, wherein determining a completeness and consistency for each decision includes generating a list of missing rules based on the one or more missing cases.

13. The computer program product of claim 8, wherein determining a completeness and consistency for each decision includes generating a list of arbitration rules.

14. The computer program product of claim 13, wherein an arbitration rule is associated with a case having at least one conflicting decision.

15. A system for optimizing a hierarchical rule-based decision policy, comprising:
a memory medium comprising instructions;
a bus coupled to the memory medium; and
a processor coupled to the bus that when executing the instructions causes the system to perform a method, comprising:
extracting, from a ruleset, an initial domain of values for each decision within the ruleset;
computing, based on the initial domain of values and a hierarchical structure of the ruleset, a reduced domain of values for each decision starting from the lowest level decision;
propagating each of the reduced domain of values upwards in the hierarchical structure; and
determining a completeness and consistency for each decision based on the propagation.

16. The system of claim 15, the method further comprising generating the hierarchical structure of the ruleset by performing a syntactic analysis of the ruleset.

17. The system of claim 15, the method further comprising computing a reduced domain of values includes constructing a limited ruleset application graph and filtering out values from the initial domain that are inconsistent with the limited ruleset application constraint graph.

18. The system of claim 15, the method further comprising computing, based on the reduced domain of values, one or more missing cases.

19. The system of claim 18, wherein determining a completeness and consistency for each decision includes generating a list of missing rules based on the one or more missing cases.

20. The system of claim 15, wherein determining a completeness and consistency for each decision includes generating a list of arbitration rules.
